(19) United States
(12) Patent Application Publication
(10) Pub. No.: US 2016/0358544 A1
(43) Pub. Date: Dec. 8, 2016

(54) OLED PIXEL DRIVING CIRCUIT AND OLED DISPLAY PANEL

(71) Applicant: Shenzhen China Star Optoelectronics Technology Co. Ltd., Shenzhen City (CN)

(72) Inventor: Jianhang Fu, Shenzhen City (CN)

(21) Appl. No.: 14/771,206

(22) PCT Filed: Jun. 23, 2015
(86) PCT No.: PCT/CN2015/082032

§ 371 Date: Aug. 28, 2015

(30) Foreign Application Priority Data
Jun. 3, 2015 (CN) 201510299466.0

(51) Int. Cl. G09G 3/3233

(52) U.S. Cl. CPC G09G 3/3233; G09G 2300/0452; G09G 2300/0819; G09G 2320/045; G09G 2310/06

(57) ABSTRACT

The present invention provides an OLED pixel driving circuit and an OLED display panel. The OLED pixel driving circuit sets a third thin film transistor (T3) between a direct current voltage end (Vdd) and an organic light emitting diode (D), and manipulates a control signal (P) to control on or off of the source and the drain of the third thin film transistor (T3) for being capable of conveniently controlling the light emitting period of an OLED. The OLED display panel sets a third thin film transistor (T3) between a direct current voltage end (Vdd) and an organic light emitting diode (D) in the OLED pixel driving circuit of each sub pixel, and manipulates a first control signal (P1) and a second control signal (P2), of which the voltage levels are opposite, to respectively control every two adjacent pixels to be in a state that one emit light and the other dose not emit light, alternately for being capable of conveniently controlling the light emitting period of the OLEDs in the respective pixels for shortening the light emitting periods of the OLEDs in respective pixels and extending the lifetime of the OLED display panel.

### FIELD OF THE INVENTION

The present invention relates to a display technology field, and more particularly to an OLED pixel driving circuit and an OLED display panel.

### BACKGROUND OF THE INVENTION

The Organic Light Emitting Display (OLED) possesses many outstanding properties of self-illumination, low driving voltage, high luminescence efficiency, short response time, high clarity and contrast, near 180° view angle, wide range of working temperature, applicability of flexible display and large scale full color display. The OLED is considered as the most potential display device.

At present, most of the OLED display devices generally utilize direct current drive and comprise an anode, a Hole Injection Layer located on the anode, a Hole Transporting Layer located on the Hole Injection Layer, an emitting layer located on the Hole Transporting Layer, an Electron Transport Layer located on the emitting layer, an Electron Injection Layer located on the Electron Transport Layer and a Cathode located on the Electron Injection Layer. The Electron and the Hole are respectively injected into the Electron and Hole Transporting Layers from the cathode and the anode. The Electron and the Hole respectively migrate from the Electron and Hole Transporting Layers to the Emitting layer and bump into each other in the Emitting layer to form an exciton to excite the emitting molecule. The latter can illuminate after the radiative relaxation.

When the electrical current flows through the OLED, the OLED emits light, and the brightness is determined according to the current flowing through the OLED itself. Most of the present Integrated Circuits (IC) only transmit voltage signals. Therefore, the OLED pixel driving circuit needs to accomplish the task of converting the voltage signals into the current signals. The present OLED pixel driving circuit generally is 2T1C, which is a structure comprising two thin film transistors and one capacitor to convert the voltage into the current.

As shown in FIG. 1, the OLED pixel driving circuit of the present 2T1C structure comprises a first thin film transistor T10, a second thin film transistor T20 and a capacitor C10. Specifically, a gate of the first thin film transistor T10 is electrically coupled to a scan line Gate, and a drain is electrically coupled to a data line Data, and a source is electrically coupled to a gate of the second thin film transistor T20 and one end of the capacitor C10; a drain of the second thin film transistor T20 is electrically coupled to a cathode of an organic light emitting diode D10, and a source is grounded; an anode of the organic light emitting diode D10 is electrically coupled to a direct current voltage end Vdd, and the cathode is electrically to the drain of the second thin film transistor T20; one end of the capacitor C10 is electrically coupled to the source of the first thin film transistor T10 and the other end is grounded. As the OLED display panel displays, the scan pulse signals are provided sequentially row by row corresponding to the scan lines of the pixels of respective rows, and the first thin film transistor T10 is activated under the control of the scan signal, and the data signal enters the gate of the second thin film transistor T20 and the capacitor C10 via the first thin film transistor T10. Then, the first thin film transistor T10 is deactivated. With the storage function of the capacitor C10, the gate voltage of the second thin film transistor T20 can remain to hold the data signal voltage to make the second thin film transistor T20 to be in the activation state, and the current enters the organic light emitting diode D10 to drive the organic light emitting diode D10 to emit light.

However, the aforesaid OLED pixel driving circuit of the 2T1C structure requires that all pixels constantly remain to be in state of emitting light when the OLED display panel displays. With the increase of the usage period of the OLED display panel, the Holes and the Electrons respectively accumulate at the interfaces of the Transporting Layers and the Emitting layer, and form internal electrical field inside the organic light emitting diode, which results in that the threshold voltage of the organic light emitting diode increases, and the illuminating brightness reduces, and the lifetime of the OLED display panel is affected.

### SUMMARY OF THE INVENTION

An objective of the present invention is to provide an OLED pixel driving circuit capable of conveniently controlling the light emitting period of an OLED.

Another objective of the present invention is to provide an OLED display panel, capable of conveniently controlling the light emitting period of an OLED for shortening the light emitting periods of the OLEDs in respective pixels and extending the lifetime of the OLED display panel.

For realizing the aforesaid objectives, the present invention provides an OLED pixel driving circuit, comprising a first thin film transistor, a second thin film transistor, a third thin film transistor, an organic light emitting diode and a capacitor;

a gate of the first thin film transistor is electrically coupled to a scan line, and a drain is electrically coupled to a data line, and a source is electrically coupled to a gate of a second thin film transistor and one end of the capacitor;

the gate of the second thin film transistor is electrically coupled to the source of the first thin film transistor and the one end of the capacitor, and a drain is electrically coupled to a cathode of the organic light emitting diode, and a source is grounded;

a gate of the third thin film transistor is electrically coupled to a control signal line of transmitting a control signal, and a drain is electrically coupled to a direct current voltage end, and a source is electrically coupled to an anode of the of the organic light emitting diode;

the anode of the organic light emitting diode is electrically coupled to the source of the third thin film transistor, and the cathode is electrically coupled to the drain of the second thin film transistor;

the one end of the capacitor is electrically coupled to the source of the first thin film transistor and the gate of the second thin film transistor, and the other end is grounded;

the control signal alternately provides high, low voltage levels to control on or off of the source and the drain of the third thin film transistor.

All of the first thin film transistor, the second thin film transistor and the third thin film transistor are Low Temperature Poly-silicon thin film transistors, oxide semiconductor thin film transistors or amorphous silicon thin film transistors.

The control signal is a pulse signal.

The control signal is provided by an external sequence controller.

The present invention further provides an OLED display panel, comprising a plurality of pixels arranged in array, and each pixel comprises a plurality of sub pixels, and each sub pixel comprises an OLED pixel driving circuit inside;

all the sub pixels at the same row are electrically coupled to a scan line corresponding to the sub pixel of the row, and all sub pixels at the same column are electrically coupled to a data line corresponding to the sub pixels of the column;

the OLED pixel driving circuit of each sub pixel comprises a first thin film transistor, a second thin film transistor, a third thin film transistor, an organic light emitting diode and a capacitor; a gate of the first thin film transistor is electrically coupled to a scan line, and a drain is electrically coupled to a data line, and a source is electrically coupled to a gate of a second thin film transistor and one end of the capacitor; the gate of the second thin film transistor is electrically coupled to the source of the first thin film transistor and the one end of the capacitor, and a drain is electrically coupled to a cathode of the organic light emitting diode, and a source is grounded; a gate of the third thin film transistor is electrically coupled to a first control signal line of transmitting a first control signal or a second control signal line of transmitting a second control signal, and a drain is electrically coupled to a direct current voltage end, and a source is electrically coupled to an anode of the of the organic light emitting diode; the anode of the organic light emitting diode is electrically coupled to the source of the third thin film transistor, and the cathode is electrically coupled to the drain of the second thin film transistor; the one end of the capacitor is electrically coupled to the source of the first thin film transistor and the gate of the second thin film transistor, and the other end is grounded;

for every two adjacent pixels, all gates of the third thin film transistors in the plurality of sub pixels of one pixel are electrically coupled to the first control signal line, and all gates of the third thin film transistors in the plurality of sub pixels of the other pixel are electrically coupled to the second control signal line;

both the first control signal and the second control signal alternately provide high, low voltage levels, and voltage levels of the first control signal and the second control signal are opposite.

Each of the pixels comprises a red sub pixel, a green sub pixel and a blue sub pixel.

The first control signal and the second control signal are pulse signals which are mutually opposite.

Both pulse durations of the first control signal and the second control signal are display periods of adjacent two frames of images.

Both the first control signal and the second control signal are provided by an external sequence controller.

All of the first thin film transistor, the second thin film transistor and the third thin film transistor are Low Temperature Poly-silicon thin film transistors, oxide semiconductor thin film transistors or amorphous silicon thin film transistors.

The present invention further provides an OLED display panel, comprising a plurality of pixels arranged in array, and each pixel comprises a plurality of sub pixels, and each sub pixel comprises an OLED pixel driving circuit inside;

all the sub pixels at the same row are electrically coupled to a scan line corresponding to the sub pixel of the row, and all sub pixels at the same column are electrically coupled to a data line corresponding to the sub pixels of the column;

the OLED pixel driving circuit of each sub pixel comprises a first thin film transistor, a second thin film transistor, a third thin film transistor, an organic light emitting diode and a capacitor; a gate of the first thin film transistor is electrically coupled to a scan line, and a drain is electrically coupled to a data line, and a source is electrically coupled to a gate of a second thin film transistor and one end of the capacitor; the gate of the second thin film transistor is electrically coupled to the source of the first thin film transistor and the one end of the capacitor, and a drain is electrically coupled to a cathode of the organic light emitting diode, and a source is grounded; a gate of the third thin film transistor is electrically coupled to a first control signal line of transmitting a first control signal or a second control signal line of transmitting a second control signal, and a drain is electrically coupled to a direct current voltage end, and a source is electrically coupled to an anode of the of the organic light emitting diode; the anode of the organic light emitting diode is electrically coupled to the source of the third thin film transistor, and the cathode is electrically coupled to the drain of the second thin film transistor; the one end of the capacitor is electrically coupled to the source of the first thin film transistor and the gate of the second thin film transistor, and the other end is grounded;

for every two adjacent pixels, all gates of the third thin film transistors in the plurality of sub pixels of one pixel are electrically coupled to the first control signal line, and all gates of the third thin film transistors in the plurality of sub pixels of the other pixel are electrically coupled to the second control signal line;

both the first control signal and the second control signal alternately provide high, low voltage levels, and voltage levels of the first control signal and the second control signal are opposite;

wherein each of the pixels comprises a red sub pixel, a green sub pixel and a blue sub pixel;

wherein the first control signal and the second control signal are pulse signals which are mutually opposite;

wherein all of the first thin film transistor, the second thin film transistor and the third thin film transistor are Low Temperature Poly-silicon thin film transistors, oxide semiconductor thin film transistors or amorphous silicon thin film transistors.

The benefits of the present invention: the present invention provides an OLED pixel driving circuit, which sets a third thin film transistor between a direct current voltage end and an organic light emitting diode, and manipulates a control signal to control on or off of the source and the drain of the third thin film transistor for being capable of conveniently controlling the light emitting period of an OLED. The present invention provides an OLED display panel, of which a third thin film transistor is set between a direct current voltage end and an organic light emitting diode in the OLED pixel driving circuit of each sub pixel, and manipulates a first control signal and a second control signal, of which the voltage levels are opposite, to respectively control every two adjacent pixels to be in a state that one emits light and the other does not emit light, alternately for being capable of conveniently controlling the light emitting period of the OLEDs in the respective pixels for shortening the light emitting periods of the OLEDs in respective pixels and extending the lifetime of the OLED display panel under the premise that the display period of the OLED display panel does not change.

### BRIEF DESCRIPTION OF THE DRAWINGS

In order to better understand the characteristics and technical aspect of the invention, please refer to the following detailed description of the present invention is concerned with the diagrams, however, provide reference to the accompanying drawings and description only and is not intended to be limiting of the invention.

In drawings,

FIG. 1 is a circuit diagram of an OLED pixel driving circuit according to prior art;

FIG. 2 is a circuit diagram of an OLED pixel driving circuit according to the present invention;

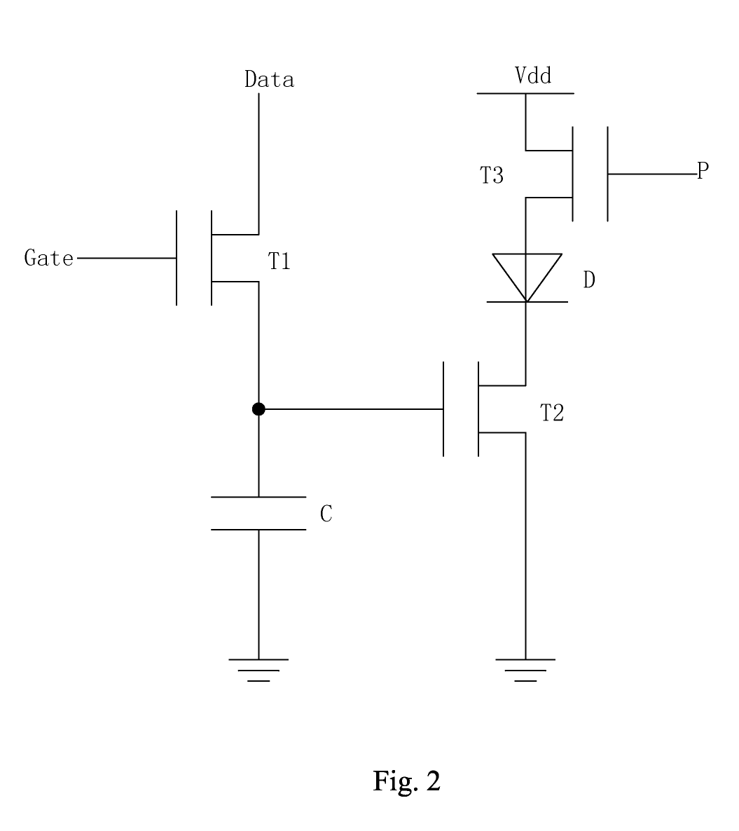

FIG. 3 is a structural diagram of an OLED display panel according to the present invention;

FIG. 4 is a circuit diagram of the OLED pixel driving circuit of each sub pixel in the OLED display panel according to the present invention;

FIG. 5 is a waveform diagram of signals used in the OLED display panel according to the present invention.

### DETAILED DESCRIPTION OF PREFERRED EMBODIMENTS

For better explaining the technical solution and the effect of the present invention, the present invention will be further described in detail with the accompanying drawings and the specific embodiments.

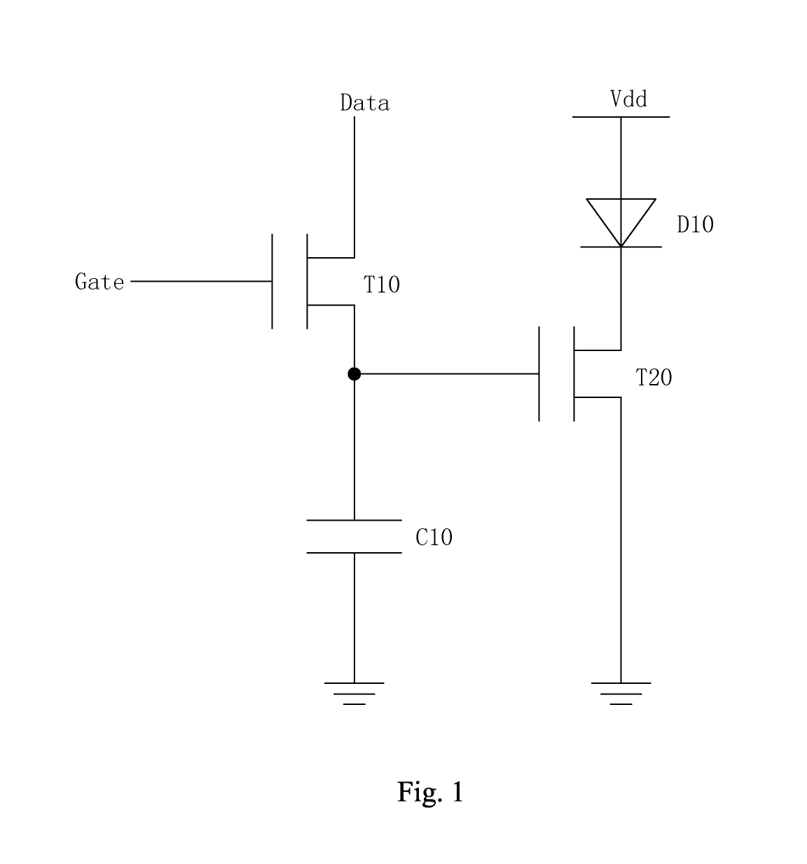

Please refer to FIG. 1 The present invention first provides an OLED pixel driving circuit, comprising a first thin film transistor T1, a second thin film transistor T2, a third thin film transistor T3, an organic light emitting diode D and a capacitor C.

A gate of the first thin film transistor T1 is electrically coupled to a scan line Gate, and a drain is electrically coupled to a data line Data, and a source is electrically coupled to a gate of a second thin film transistor T2 and one end of the capacitor C;

The gate of the second thin film transistor T2 is electrically coupled to the source of the first thin film transistor T1 and the one end of the capacitor C, and a drain is electrically coupled to a cathode of the organic light emitting diode D, and a source is grounded;

a gate of the third thin film transistor T3 is electrically coupled to a control signal line of transmitting a control signal P, and a drain is electrically coupled to a direct current voltage end Vdd, and a source is electrically coupled to an anode of the of the organic light emitting diode D;

the anode of the organic light emitting diode D is electrically coupled to the source of the third thin film transistor T3, and the cathode is electrically coupled to the drain of the second thin film transistor T2;

the one end of the capacitor C is electrically coupled to the source of the first thin film transistor T1 and the gate of the second thin film transistor T2, and the other end is grounded.

The control signal P alternately provides high, low voltage levels. The scan line Gate provides a pulse signal to the gate of the first thin film transistor T1 to activate the first thin film transistor T1. The data signal enters the gate of the second thin film transistor T2 and the capacitor C via the first thin film transistor T1 to be stored in the capacitor C for making the second thin film transistor T2 keep in an activation state. When the control signal P provides a high voltage level, the gate of the third thin film transistor T3 is controlled by the high voltage level. Correspondingly, the source and the drain of the third thin film transistor T3 are conducted. The current path is formed among the direct current voltage end Vdd, the third thin film transistor T3, the organic light emitting diode D and the second thin film transistor T2, and the electrical current flow through the organic light emitting diode D to make it emit light; when the control signal P provides a low voltage level, the gate of the third thin film transistor T3 is controlled by the low voltage level. Correspondingly, the source and the drain of the third thin film transistor T3 are disconnected, and only the second thin film transistor T2 remains to be in the activation state. However, the source and the drain of the third thin film transistor are disconnected, an open circuit is formed among the direct current voltage end Vdd, the third thin film transistor T3, the organic light emitting diode D and the second thin film transistor T2, and the organic light emitting diode D stops emitting light because no electrical current flows therethrough. Accordingly, it is capable of conveniently controlling the light emitting period of the OLED.

Specifically, all of the first thin film transistor T1, the second thin film transistor T2 and the third thin film transistor T3 are Low Temperature Poly-silicon thin film transistors, oxide semiconductor thin film transistors or amorphous silicon thin film transistors.

The control signal P can be a pulse signal and provided by an external sequence controller.

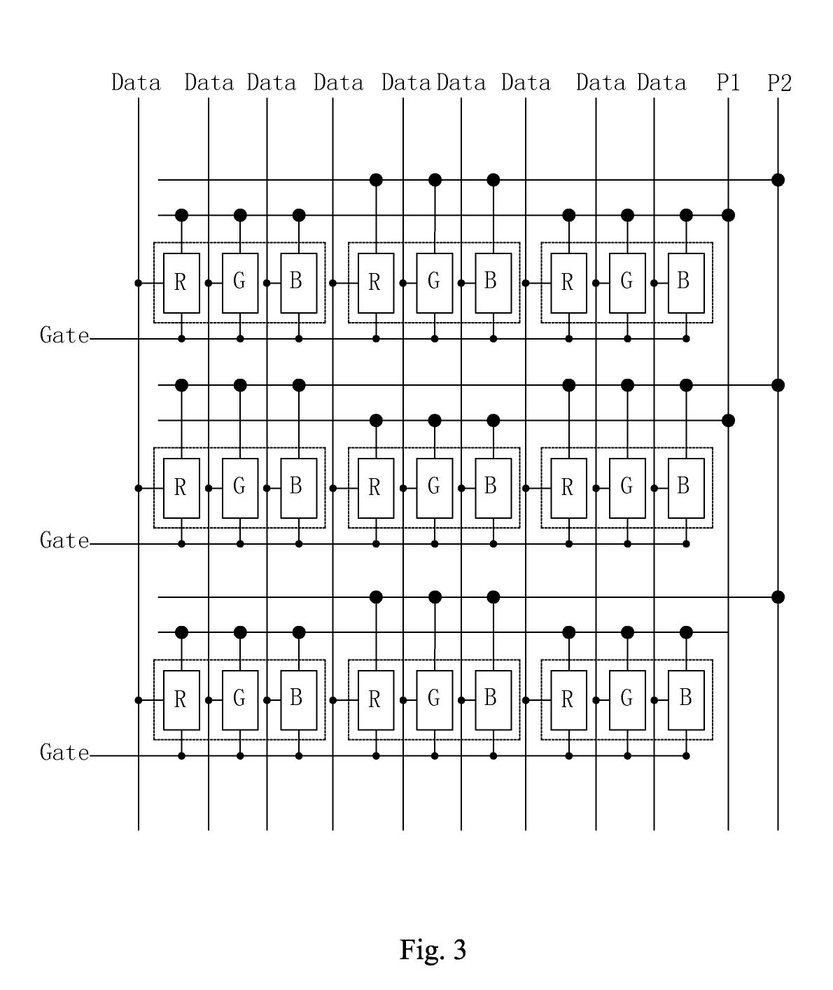

Please refer from FIG. 3 to FIG. 5. The present invention further provides an OLED display panel. As shown in FIG. 3, the OLED display panel comprises a plurality of pixels arranged in array, and each pixel comprises a plurality of sub pixels. FIG. 3 merely shows that each pixel comprises a red sub pixel R, a green sub pixel G and a blue sub pixel B. Certainly, each sub pixel comprises red, green, blue, cyan, four sub pixels, or red, green, blue, yellow, four sub pixels or red, green, blue, white, four sub pixels. Each sub pixel comprises an OLED pixel driving circuit inside.

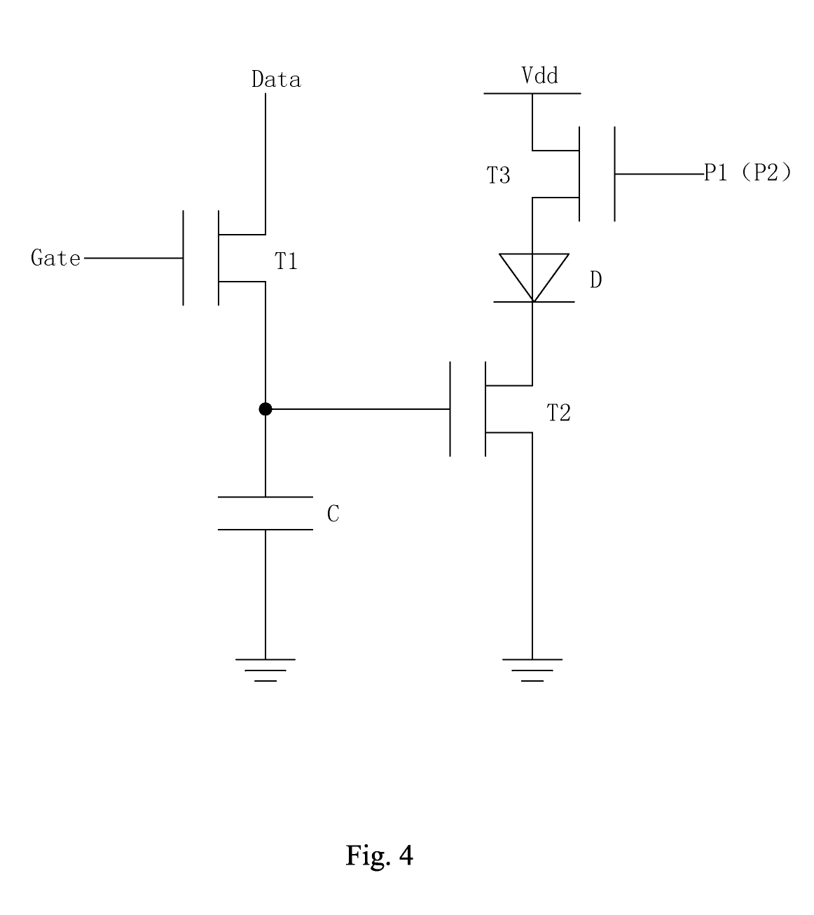

Combining FIG. 3 and FIG. 4, all the sub pixels at the same row are electrically coupled to a scan line Gate corresponding to the sub pixel of the row, and all sub pixels at the same column are electrically coupled to a data line Data corresponding to the sub pixels of the column.

The OLED pixel driving circuit of each sub pixel comprises a first thin film transistor T1, a second thin film transistor T2, a third thin film transistor T3, an organic light emitting diode D and a capacitor C; a gate of the first thin film transistor T1 is electrically coupled to a scan line Gate, and a drain is electrically coupled to a data line Data, and a source is electrically coupled to a gate of a second thin film transistor T2 and one end of the capacitor C; the gate of the second thin film transistor T2 is electrically coupled to the source of the first thin film transistor T1 and the one end of the capacitor C, and a drain is electrically coupled to a cathode of the organic light emitting diode D, and a source is grounded; a gate of the third thin film transistor T3 is electrically coupled to a first control signal line of transmitting a first control signal P1 or a second control signal line of transmitting a second control signal P2, and a drain is electrically coupled to a direct current voltage end Vdd, and a source is electrically coupled to an anode of the of the organic light emitting diode D; the anode of the organic light emitting diode D is electrically coupled to the source of the third thin film transistor T3, and the cathode is electrically coupled to the drain of the second thin film transistor T2; the one end of the capacitor C is electrically coupled to the source of the first thin film transistor T1 and the gate of the second thin film transistor T2, and the other end is grounded.

For every two adjacent pixels, all gates of the third thin film transistors T3 in the plurality of sub pixels of one pixel are electrically coupled to the first control signal line, and all gates of the third thin film transistors T3 in the plurality of sub pixels of the other pixel are electrically coupled to the second control signal line.

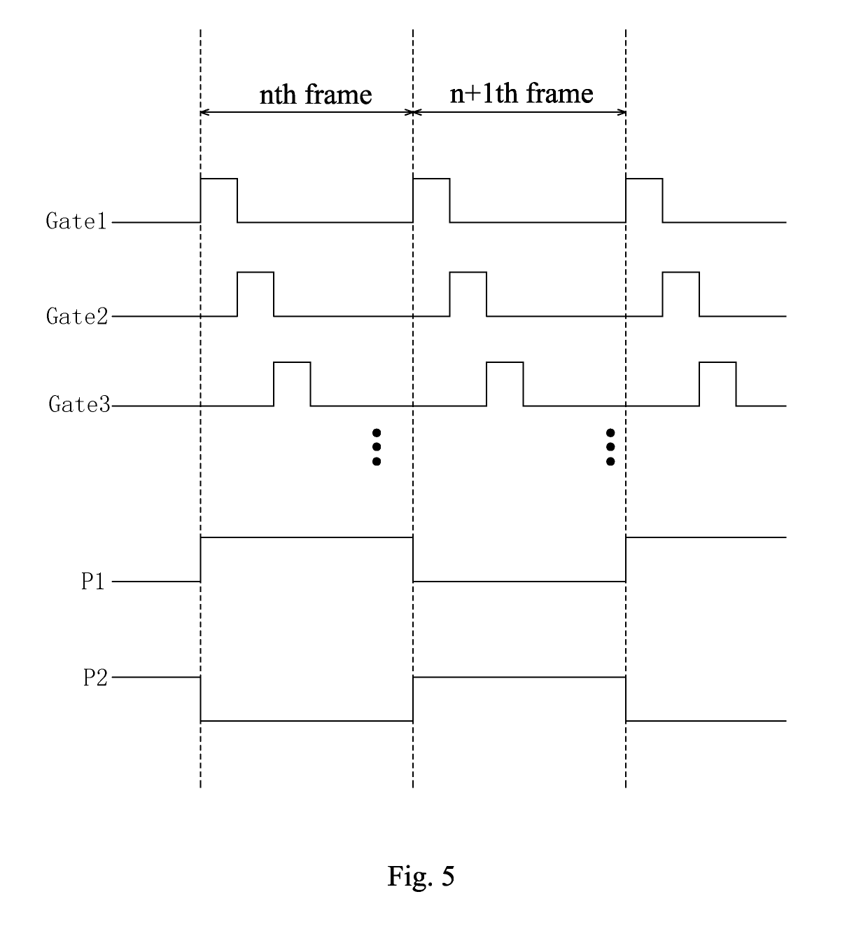

Both the first control signal P1 and the second control signal P2 alternately provide high, low voltage levels, and voltage levels of the first control signal P1 and the second control signal P2 are opposite. Preferably, as shown in FIG. 5, the first control signal P1 and the second control signal P2 are pulse signals which are mutually opposite, and both pulse durations of the first control signal P1 and the second control signal P2 are display periods of adjacent two frames of images.

Combining FIG. 3, FIG. 4 and FIG. 5, n is set to be a positive integer. In the display period of nth frame of image, the scan line Gate provides scan pulse signals Gate1, Gate2, Gate3, and etc. row by row. The scan pulse signals row by row activate the first thin film transistors T1 in the pixels of each row. The data signal enters the gate of the second thin film transistor T2 and the capacitor C via the first thin film transistor T1 to be stored in the capacitor C for making the second thin film transistor T2 keep in an activation state. In the display period of nth frame of image, the first control signal P1 always provides the high voltage level, and the second control signal P2 always provides the low voltage level. Correspondingly, for every two adjacent pixels, all gates of the third thin film transistors T3 in the plurality of sub pixels of one pixel are controlled by the first control signal P1 to conduct the sources and the drains, and a path is formed among the third thin film transistors T3, the organic light emitting diode D and the second thin film transistor T2, and the electrical current is formed and flows through the organic light emitting diode D, and the pixel emits light; all gates of the third thin film transistors T3 in the plurality of sub pixels of the other pixel are controlled by the second control signal P2 to disconnect the sources and the drains. Then, only the second thin film transistor T2 is activated. However, the sources and the drains of the third thin film transistors T3 are disconnected, an open circuit is formed among the third thin film transistor T3, the organic light emitting diode D and the second thin film transistor T2, and the pixel does not emit light because no electrical current flows through the organic light emitting diode D.

In the display period of n+1th frame of image, the scan line Gate provides scan pulse signals Gate1, Gate2, Gate3, and etc. row by row, again. The scan pulse signals row by row activate the first thin film transistors T1 in the pixels of each row. The data signal enters the gate of the second thin film transistor T2 and the capacitor C via the first thin film transistor T1 to be stored in the capacitor C for making the second thin film transistor T2 keep in an activation state. In the display period of n+1th frame of image, the first control signal P1 changes and always provides the low voltage level, and the second control signal P2 changes and always provides the high voltage level. The sources and drains of the third thin film transistors T3, which previously are disconnected in the display period of nth frame of image changes to be conducted, and the sources and drains of the third thin film transistors T3, which previously are conducted in the display period of nth frame of image changes to be disconnected. Thus, the pixels which previously emit light in the display period of nth frame of image, changes to not to emit light in the display period of n+1th frame of image, and the pixels which previously do not emit light in the display period of nth frame of image, changes to emit light in the display period of n+1th frame of image to achieve manipulating the first control signal P1 and the second control signal P2, of which the voltage levels are opposite, to respectively control every two adjacent pixels to be in a state that one emit light and the other dose not emit light, alternately in the display process. In each frame of image, only half pixels emit light. The light emitting periods of the OLEDs in respective pixels are shortened to be half and the lifetime of the OLED display panel can be extended under the premise that the display period of the OLED display panel does not change.

In conclusion, the OLED pixel driving circuit of the present invention sets a third thin film transistor between a direct current voltage end and an organic light emitting diode, and manipulates a control signal to control on or off of the source and the drain of the third thin film transistor for being capable of conveniently controlling the light emitting period of an OLED. In the present invention provides an OLED display panel, a third thin film transistor is set between a direct current voltage end and an organic light emitting diode in the OLED pixel driving circuit of each sub pixel, and manipulates a first control signal and a second control signal, of which the voltage levels are opposite, to respectively control every two adjacent pixels to be in a state that one emits light and the other does not emit light, constantly for being capable of conveniently controlling the light emitting period of the OLEDs in the respective pixels for shortening the light emitting periods of the OLEDs in respective pixels and extending the lifetime of the OLED display panel under the premise that the display period of the OLED display panel does not change.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. An OLED pixel driving circuit, comprising a first thin film transistor, a second thin film transistor, a third thin film transistor, an organic light emitting diode and a capacitor;
a gate of the first thin film transistor is electrically coupled to a scan line, and a drain is electrically coupled to a data line, and a source is electrically coupled to a gate of a second thin film transistor and one end of the capacitor;
the gate of the second thin film transistor is electrically coupled to the source of the first thin film transistor and the one end of the capacitor, and a drain is electrically coupled to a cathode of the organic light emitting diode, and a source is grounded;
a gate of the third thin film transistor is electrically coupled to a control signal line of transmitting a control signal, and a drain is electrically coupled to a direct current voltage end, and a source is electrically coupled to an anode of the of the organic light emitting diode;
the anode of the organic light emitting diode is electrically coupled to the source of the third thin film transistor, and the cathode is electrically coupled to the drain of the second thin film transistor;
the one end of the capacitor is electrically coupled to the source of the first thin film transistor and the gate of the second thin film transistor, and the other end is grounded;
the control signal alternately provides high, low voltage levels to control on or off of the source and the drain of the third thin film transistor.

2. The OLED pixel driving circuit according to claim 1, wherein all of the first thin film transistor, the second thin film transistor and the third thin film transistor are Low Temperature Poly-silicon thin film transistors, oxide semiconductor thin film transistors or amorphous silicon thin film transistors.

3. The OLED pixel driving circuit according to claim 1, wherein the control signal is a pulse signal.

4. The OLED pixel driving circuit according to claim 3, wherein the control signal is provided by an external sequence controller.

5. An OLED display panel, comprising a plurality of pixels arranged in array, and each pixel comprises a plurality of sub pixels, and each sub pixel comprises an OLED pixel driving circuit inside;
all the sub pixels at the same row are electrically coupled to a scan line corresponding to the sub pixel of the row, and all sub pixels at the same column are electrically coupled to a data line corresponding to the sub pixels of the column;
the OLED pixel driving circuit of each sub pixel comprises a first thin film transistor, a second thin film transistor, a third thin film transistor, an organic light emitting diode and a capacitor; a gate of the first thin film transistor is electrically coupled to a scan line, and a drain is electrically coupled to a data line, and a source is electrically coupled to a gate of a second thin film transistor and one end of the capacitor; the gate of the second thin film transistor is electrically coupled to the source of the first thin film transistor and the one end of the capacitor, and a drain is electrically coupled to a cathode of the organic light emitting diode, and a source is grounded; a gate of the third thin film transistor is electrically coupled to a first control signal line of transmitting a first control signal or a second control signal line of transmitting a second control signal, and a drain is electrically coupled to a direct current voltage end, and a source is electrically coupled to an anode of the of the organic light emitting diode; the anode of the organic light emitting diode is electrically coupled to the source of the third thin film transistor, and the cathode is electrically coupled to the drain of the second thin film transistor; the one end of the capacitor is electrically coupled to the source of the first thin film transistor and the gate of the second thin film transistor, and the other end is grounded;
for every two adjacent pixels, all gates of the third thin film transistors in the plurality of sub pixels of one pixel are electrically coupled to the first control signal line, and all gates of the third thin film transistors in the plurality of sub pixels of the other pixel are electrically coupled to the second control signal line;
both the first control signal and the second control signal alternately provide high, low voltage levels, and voltage levels of the first control signal and the second control signal are opposite.

6. The OLED display panel according to claim 5, wherein each of the pixels comprises a red sub pixel, a green sub pixel and a blue sub pixel.

7. The OLED display panel according to claim 5, wherein the first control signal and the second control signal are pulse signals which are mutually opposite.

8. The OLED display panel according to claim 7, wherein both pulse durations of the first control signal and the second control signal are display periods of adjacent two frames of images.

9. The OLED display panel according to claim 8, wherein both the first control signal and the second control signal are provided by an external sequence controller.

10. The OLED display panel according to claim 5, wherein all of the first thin film transistor, the second thin film transistor and the third thin film transistor are Low Temperature Poly-silicon thin film transistors, oxide semiconductor thin film transistors or amorphous silicon thin film transistors.

11. An OLED display panel, comprising a plurality of pixels arranged in array, and each pixel comprises a plurality of sub pixels, and each sub pixel comprises an OLED pixel driving circuit inside;
all the sub pixels at the same row are electrically coupled to a scan line corresponding to the sub pixel of the row, and all sub pixels at the same column are electrically coupled to a data line corresponding to the sub pixels of the column;
the OLED pixel driving circuit of each sub pixel comprises a first thin film transistor, a second thin film transistor, a third thin film transistor, an organic light emitting diode and a capacitor; a gate of the first thin film transistor is electrically coupled to a scan line, and a drain is electrically coupled to a data line, and a source is electrically coupled to a gate of a second thin film transistor and one end of the capacitor; the gate of the second thin film transistor is electrically coupled to the source of the first thin film transistor and the one end of the capacitor, and a drain is electrically coupled to a cathode of the organic light emitting diode, and a source is grounded; a gate of the third thin film transistor is electrically coupled to a first control signal line of transmitting a first control signal or a second control signal line of transmitting a second control signal, and a drain is electrically coupled to a direct current voltage end, and a source is electrically coupled to an anode of the of the organic light emitting diode; the anode of the organic light emitting diode is electrically coupled to the source of the third thin film transistor, and the cathode is electrically coupled to the drain of the second thin film transistor; the one end of the capacitor is electrically coupled to the source of the first thin film transistor and the gate of the second thin film transistor, and the other end is grounded;
for every two adjacent pixels, all gates of the third thin film transistors in the plurality of sub pixels of one pixel are electrically coupled to the first control signal line, and all gates of the third thin film transistors in the plurality of sub pixels of the other pixel are electrically coupled to the second control signal line;
both the first control signal and the second control signal alternately provide high, low voltage levels, and voltage levels of the first control signal and the second control signal are opposite;
wherein each of the pixels comprises a red sub pixel, a green sub pixel and a blue sub pixel;
wherein the first control signal and the second control signal are pulse signals which are mutually opposite;
wherein all of the first thin film transistor, the second thin film transistor and the third thin film transistor are Low Temperature Poly-silicon thin film transistors, oxide semiconductor thin film transistors or amorphous silicon thin film transistors.

12. The OLED display panel according to claim 11, wherein both pulse durations of the first control signal and the second control signal are display periods of adjacent two frames of images.

13. The OLED display panel according to claim 12, wherein both the first control signal and the second control signal are provided by an external sequence controller.
